(19) United States
(12) Patent Application Publication
(10) Pub. No.: US 2009/0087271 A1
(43) Pub. Date: Apr. 2, 2009

(54) Device for the High-Speed Drilling of Boards for Printed Circuits

(76) Inventor: Gioachino Busatta, Bassano Del Grappa VI (IT)

Correspondence Address: STRADLEY RONON STEVENS & YOUNG, LLP, 30 VALLEY STREAM PARKWAY, GREAT VALLEY CORPORATE CENTER, MALVERN, PA, 19355-1481, US

(21) Appl. No.: 12/084,336

(22) PCT Filed: Oct. 27, 2006
(86) PCT No.: PCT/IT2006/000760

§ 371 Date: Apr. 28, 2008

(30) Foreign Application Priority Data
Oct. 28, 2005 (IT) PD2005A00321

(51) Int. Cl. B23B 47/00

(52) U.S. Cl. 408/69

(57) ABSTRACT

A device for the high-speed drilling of boards for printed circuits and the like. The device has a support, a drill head with an associated mandrel and a workpiece-pressing device mounted on the support, which can be displaced relative thereto towards and away from the board to be drilled. At least one actuator is interposed between the support, the drill head and/or the workpiece-pressing device in order to move the drill head and the workpiece-pressing device with respect to the support. The workpiece-pressing device may be displaced on the support independently from the drill head.

The present invention relates to a device for the high-speed drilling of boards for printed circuits and the like.

### TECHNICAL FIELD

When machining boards for printed circuits, the board has to be drilled in at least some of the zones of welding of the circuit components. The current trend is towards an ongoing increase in the density of holes per unit of area and a reduction of their diameter.

### TECHNOLOGICAL BACKGROUND

For this purpose, use is generally made of high-speed electric mandrels whose drill head is guided along an axis (z) to and from the board to be drilled. The devices in question comprise a workpiece-pressing device which is adapted to press the board at the drilling point before and during the actual drilling. The workpiece-pressing device therefore has to be positioned, keyed and pressed on the board and then raised away from the board for the execution of each individual hole. It is therefore subject to many displacements towards and away from the board during drilling.

Bearing in mind the speeds involved (the device of the invention is adapted to enable more than 20 holes to be dilled per second), even apparently small mass displacements become a critical factor.

The drilling devices used up to now do not take appropriate account of this critical factor and have thus played their pat in limiting the maximum drilling speed that has up to now been practicable. At present, no more than eight holes per second can be drilled with the fastest devices, which is far from market requirements in terms of the economic machining of the boards in question.

### DESCRIPTION OF THE INVENTION

In the light of the above, the technical problem underlying the present invention is that of providing a drilling device for printed circuit boards which is structurally and functionally designed to enable the limits of the cited prior art to be remedied.

In the context of this problem, the main object of the present invention is to provide a drilling device which substantially reduces the masses subject to acceleration during the various drilling phases.

This problem is resolved and this and other objects are achieved by a drilling device embodied in accordance with the accompanying claims.

The notion of the solution underlying the present invention is based on the observation that known devices involve an unnecessary movement of the workpiece-pressing device which is normally connected to the drill head and therefore follows its movements towards and away from the board. According to the invention, the device is caused to move independently with respect to the drill head, and is actuated by an independent positioning actuator only in the initial stage of positioning and adjustment of the so-called “planar circuit” while any other movement towards and away from the board to be drilled is carried out by means of an independent actuator, for instance of piezoelectric type, actuated at a frequency equal to the drilling frequency so as to work in a synchronised manner with the drill head. An actuator of voice coil or like type may be efficiently used as an alternative to a piezoelectric actuator.

### BRIEF DESCRIPTION OF THE DRAWINGS

The characteristic features and advantages of the invention are set out in the following detailed description of a preferred embodiment thereof, shown by way of non-limiting example in the accompanying drawings, in which:

FIG. 1 is a perspective view of a device for the high-speed drilling of boards for printed circuits and the like;

FIG. 2 is a front elevation of the device of FIG. 1;

FIG. 3 is a perspective view, in longitudinal section, of a detail of the device of FIG. 1;

FIG. 4 is a perspective view of a variant of the device of the invention.

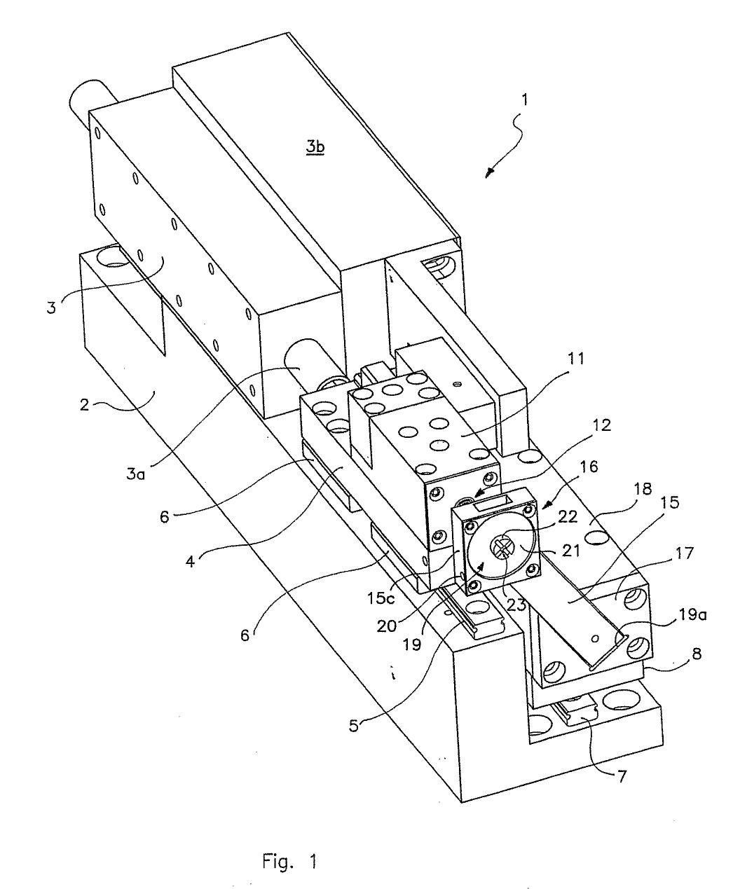

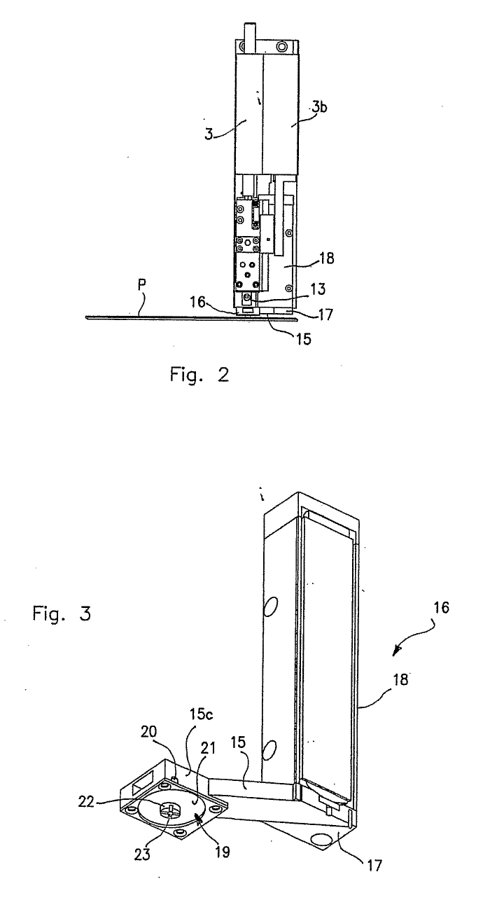

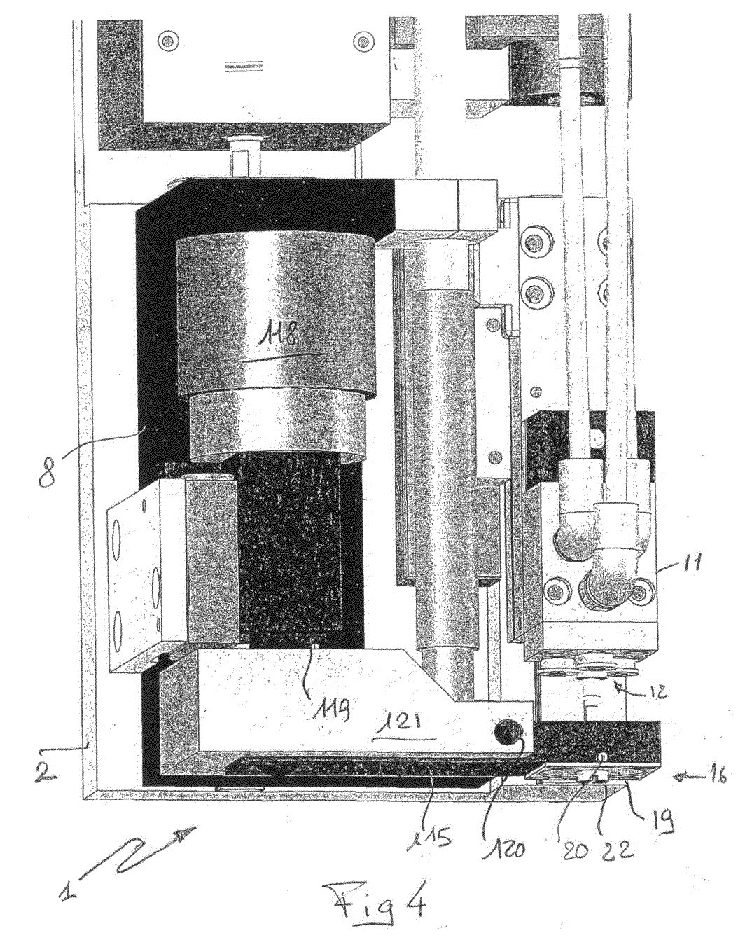

### PREFERRED EMBODIMENT OF THE INVENTION

In the drawings, a device for the high-speed drilling of boards for printed circuits and the like is shown overall by 1. The device 1 comprises a support 2 on which a linear actuator 3 is mounted, whose rod 3a acts on a first carriage 4. The first carriage 4 is mounted to slide on the support 2 by means of guides 5 and shoes 6; a second carriage 8 which may also slide on the support 2 by means of a second actuator 3b is mounted on different guides 7 and comprises similar shoes (not shown). The second carriage 8 is normally locked with respect to the support 2.

A drill head 11 is mounted on the first carriage 4 and comprises a mandrel 12 able to drive a drill bit 13 in rotation at high speed. The actuator 3 displaces the first carriage 4 towards and away from a board P to be drilled during the desired drilling movements.

The second carriage, together with an arm 15 mounted thereon, is part of a workpiece-pressing device shown overall by 16 which is adapted to press the board P against a working surface (not shown) during drilling by means of the bit 13.

The arm 15 is embodied as a leaf spring extending in a cantilevered and projecting manner from a plate 17 which at the bottom closes an actuator member 18. The arm 15 is made in one piece with the plate 17 and ends at one of its roots in a weakened line 19a cut into the plate 17 which is adapted to create a preferential resiliently yielding zone about which the arm 15 tends to oscillate when actuated by the actuator 18.

The actuator 18 is of piezoelectric type and is adapted to promote the alternating oscillating movement of the arm 15 about the weakened line 19a. At the free end of the arm 15, opposite its root, there is formed a support 15c on which a pressure member 19 is mounted and is free to oscillate about a diametric axis 20 so as to be disposed coplanar to the board P when bearing thereon. The pressure member 19 is shaped as an annular bushing with a crown 21 of greater diameter and a crown 22 of smaller diameter which are coaxial and both provided with a central hole 23.

A variant of the device 1 is shown in FIG. 4. Details similar to those of the preceding embodiment bear the same reference numerals. The actuator of the embodiment of FIG. 4, shown by 118, is of the type known as a voice coil actuator and is connected by means of a control rod 119 to the arm 115 of the workpiece-pressing device 16. The arm 115 is in turn hinged at the location of a pin 120 on a fork support 121 which is stationary on the carriage 8. The actuation of the actuator 118 therefore generates an oscillation, whose frequency can be controlled and adjusted, of the arm 115 about the pin 120 thereby raising and lowering the pressure member 19 towards and away from the board P to be drilled.

The device 1 operates as follows.

The drilling device 1 is actuated by means of a computerised digital control which does not form part of the subject matter of the present invention. The first operation prior to the stage of drilling of the board P is therefore to determine the so-called “planar circuit” position so that the control learns for which coordinates the head 11 and the workpiece pressing device 16 are physically in a predetermined position with respect to the board P.

For this first operation, the second carriage 8 displaces the workpiece-pressing device 16 until it brings the latter to contact the board P with a predetermined contact pressure. When the assembly is raised by a predetermined extent, the second carriage 8 is locked with respect to the support 2. In these conditions, the linear actuator 3 governs only the actuation of the drill head 11 and is subject to the forces of inertia relating only to its mass which are substantially smaller than those relating to the overall mass of the head 11 and workpiece-pressing device 16. It will be appreciated that the reduction of the masses in question in turn makes it possible to reduce the dimensions of the linear actuator 3 and its rod 3a which helps further to reduce the overall forces of inertia involved.

The workpiece-pressing device 16 is actuated towards and away from the board P by the piezoelectric actuator 18 or voice coil actuator 118, whose action is adjusted by varying the supply frequency thereof. This frequency variation, obtained for instance by an inverter, corresponds to the same frequency variation of the cycle of pressure and raising of the arm 15 (as a result of the known piezoelectric properties of piezoelectric actuators and electromagnetic properties of voice coil actuators) and therefore of the pressure member 19 which alternates between a position pressed against the board P and a position raised therefrom. The supply frequency of the actuator is therefore adjusted to coincide with the frequency of the drilling cycle carried out by means of the bit 13.

Moreover, varying the distance of the board P to be drilled with respect to the workpiece-pressing device 16 adjusts the pressure exerted by the pressure member on the board, both because the resilient reaction opposed by the arm 15 varies because the resulting displacement differs and because the pressure exerted by the actuator 18, 118 varies as its stroke varies, without having to act on other (hydraulic or pneumatic) operating parameters of the device.

The invention thus resolves the problem set out above and offers many advantages with respect to the technical solutions known up to now, all of which focus chiefly on increasing the drilling speed and the hourly output that can be achieved.

1. A device for the high-speed drilling of boards for printed circuits and the like comprising:
a support;
a drill head with an associated mandrel and a workpiece-pressing device mounted on the support, which can be displaced relative thereto towards and away from the board to be drilled; and
at least one actuator interposed between the support, the drill head and/or the workpiece-pressing device in order to move the drill head and the workpiece-pressing device with respect to the support,
wherein the workpiece-pressing device may be displaced on the support independently from the drill head.

2. The device according to claim 1, further comprising a first guide provided on the support and a pressure member, and wherein the workpiece-pressing device comprises a carriage guided in a sliding manner on the first guide and an arm, mounted on the carriage, which supports the pressure member and may be oscillated with respect to the carriage towards and away therefrom during the movement to lock the board to be drilled toward and away therefrom.

3. The device according to claim 2, wherein a piezoelectric actuator or an actuator of voice coil type is interposed between the carriage and the arm.

4. The device according to claim 2, wherein the pressure member is shaped as a bushing supported in an oscillating manner on the arm so that it can be self-positioned coplanar to the board when pressed thereon.

5. The device according to claim 2, further comprising a second guide provided on the support and wherein the drill head and the carriage are mounted on the respective and separate first and second guides provided on the support.

6. The device according to claim 2, wherein the arm has at least one resilient section.

7. The device according to claim 6, wherein the arm is shaped as a cantilevered leaf spring projecting from the carriage.

8. The device according to claim 6, wherein the arm has a free end on which the pressure member is supported and a root opposite the free end that engages a line of preferential resilient yielding.

9. The device according to claim 2, further comprising a stage mounted on the carriage and wherein the arm is oscillated on the stage.

10. A device for the high-speed drilling of boards for printed circuits and the like comprising:
a support having a first guide;
a drill head with an associated mandrel adapted to drive a drill bit and mounted on the support;
a workpiece-pressing device mounted on the support, which can be displaced relative thereto towards and away from the board to be drilled, the workpiece-pressing device having a carriage guided in a sliding manner on the first guide and an arm, mounted on the carriage and having at least one resilient section, which supports a pressure member and may be oscillated with respect to the carriage towards and away therefrom during the movement to lock the board to be drilled, the pressure member being shaped as a bushing supported in an oscillating manner on the arm so that it can be self-positioned coplanar to the board when pressed thereon; and
at least one actuator interposed between the support, the drill head and/or the workpiece-pressing device in order to move the drill head and the workpiece-pressing device with respect to the support,
wherein the workpiece-pressing device may be displaced on the support independently from the drill head.

11. The device according to claim 10, wherein a piezoelectric actuator or an actuator of voice coil type is interposed between the carriage and the arm.

12. The device according to claim 10, further comprising a second guide provided on the support and wherein the drill head and the carriage are mounted on the respective and separate first and second guides provided on the support.

13. The device according to claim 10, wherein the arm is shaped as a cantilevered leaf spring projecting from the carriage.

14. The device according to claim 10, wherein the arm has a free end on which the pressure member is supported and a root opposite the free end that engages a line of preferential resilient yielding.

15. The device according to claim 10, further comprising a stage mounted on the carriage and wherein the arm is oscillated on the stage.

16. A device for the high-speed drilling of boards for printed circuits and the like comprising:
a support having a first guide and a separate second guide;
a drill head with an associated mandrel adapted to drive a drill bit and slidably mounted on the support via the first guide;
a workpiece-pressing device mounted on the support, which can be displaced relative thereto towards and away from the board to be drilled, the workpiece-pressing device having a carriage guided in a sliding manner on the second guide and an arm, mounted on the carriage and having at least one resilient section, which supports a pressure member and may be oscillated with respect to the carriage towards and away therefrom during the movement to lock the board to be drilled, the pressure member being shaped as a bushing supported in an oscillating manner on the arm so that it can be self-positioned coplanar to the board when pressed thereon;
a first actuator interposed between the support and the drill head to move the drill head with respect to the support; and
a piezoelectric actuator or an actuator of voice coil type interposed between the carnage and the arm of the workpiece-pressing device to move the workpiece-pressing device with respect to the support,
wherein the workpiece-pressing device may be displaced on the support independently from the drill head.

17. The device according to claim 16, wherein the arm is shaped as a cantilevered leaf spring projecting from the carriage.

18. The device according to claim 16, wherein the arm has a free end on which the pressure member is supported and a root opposite the free end that engages a line of preferential resilient yielding.

19. The device according to claim 16, further comprising a stage mounted on the carriage and wherein the arm is oscillated on the stage.
